(19) United States
(12) Patent Application Publication
(10) Pub. No.: US 2023/0228427 A1
(43) Pub. Date: Jul. 20, 2023

(54) AUTOMATIC STOVETOP CONTROL KNOB AND METHOD OF OPERATING A STOVETOP USING THERMAL IMAGING

(71) Applicant: Haier US Appliance Solutions, Inc., Wilmington, DE (US)

(72) Inventors: Juan Manuel Huerta, Edinburg, TX (US); Srikanth Raavi Venkata, Louisville, KY (US); Abdel Hamad, Louisville, KY (US); James Lee Armstrong, Louisville, KY (US); Steven Michael Recio, Louisville, KY (US)

(21) Appl. No.: 17/579,641

(22) Filed: Jan. 20, 2022

(51) Int. Cl. F24C 7/08; A47J 36/32; G06V 20/68; G06V 10/82; G05G 1/08

(52) U.S. Cl. CPC F24C 7/083; A47J 36/32; G06V 20/68; G06V 10/82; G05G 1/08; G01J 2005/0077

(57) ABSTRACT

An automatic control system for a cooking appliance monitors and adjusts a cooking operation on the cooking appliance. The automatic control system includes at least one control knob assembly, an image capturing device, and a controller operably coupled to the at least one control knob assembly and the image capturing device. The controller is configured to perform a series of operations, including receiving a desired temperature of a food item; capturing a first image of the food item; analyzing, by one or more computing devices using a machine learning image recognition model, the first image to determine one or more features of the food item; generating an input state of the food item based on the first image analysis; and determining an output action via a reinforcement learning system.

### FIELD OF THE INVENTION

The present subject matter relates generally to kitchen appliances, and more particularly to stovetops and control knobs for automatically controlling stovetops.

### BACKGROUND OF THE INVENTION

Cooking appliances generally include one or more cooktop burners capable of providing heat to cookware to heat or cook various food items. For instance, pots, pans, or other dishes having food therein may be placed on the cooktop burner to receive heat. These cooktop burners or heating elements can be controlled by knobs, for instance, for fine tuning an amount of heat produced by the heating element or burner. During a cooking operation, a user may routinely adjust the heat output of the heating element by turning the knob to increase or decrease the amount of heat produced. Accordingly, relatively quick or high temperature actions such as quick boils, meat searing, or the like can be accomplished with a high heat output, while lower temperature actions such as marinating, simmering, or the like can be accomplished with a lower heat output.

However, current cooking appliances experience drawbacks. Precise temperature control may be difficult, as many control knobs include arbitrary markings and experience a relatively large degree of slack or inaccuracy. Moreover, users must remain fairly vigilant to avoid overcooking, burning, or otherwise damaging food items or cookware on the heating element. Further still, it is difficult to determine when certain foods have reached a safe temperature for consumption by visual observation. Accordingly, further improvements are required to better control cooking operations.

An automatic control system for a cooking appliance that obviates one or more of the above-mentioned drawbacks would be beneficial. In particular, a control system to automatically monitor food items and adjust a level of heat applied to the food items would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an automatic control system for a cooking appliance is provided. The cooking appliance may include a top surface, a control panel, a heating element mounted to the top surface, and a user input provided at the control panel. The automatic control system may include at least one control knob assembly for adjusting a power level of the heating element; an image capturing device configured to capture images of the top surface; and a controller operably coupled to the at least one control knob assembly and the image capturing device, the controller being configured to perform a series of operations. The series of operations may include receiving a desired temperature of a food item provided on the top surface; capturing a first image of the food item via the image capturing device; analyzing, by one or more computing devices using a machine learning image recognition model, the first image to determine one or more features of the food item; generating an input state of the food item based on the one or more features of the food item; determining an output action via a reinforcement learning system, the reinforcement learning system including a neural network policy; and instructing the control knob assembly to adjust the power level of the heating element in response to determining the output action.

In another exemplary aspect of the present disclosure, a method of operating a cooking appliance is provided. The cooking appliance may include a top surface, a heating element, a control knob assembly, and an image capturing device. The method may include receiving a desired temperature of a food item provided on the top surface, capturing a first image of the food item via the image capturing device, analyzing, by one or more computing devices using a machine learning image recognition model, the first image to determine one or more features of the food item, generating an input state of the food item based on the first image analysis, determining an output action via a reinforcement learning system, the reinforcement learning system including a neural network policy, and instructing the control knob assembly to adjust a power level of the heating element in response to determining the output action.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a system according to exemplary embodiments of the present disclosure.

FIG. 2 provides a side schematic view of the exemplary system of FIG. 1.

FIG. 3 provides a perspective view of an exemplary cooktop according to the present disclosure.

FIG. 4 provides a cut-away section view of an exemplary knob assembly according to the present disclosure.

FIG. 5 provides a flow chart illustrating a method of operating a control system for a cooking appliance.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present disclosure. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

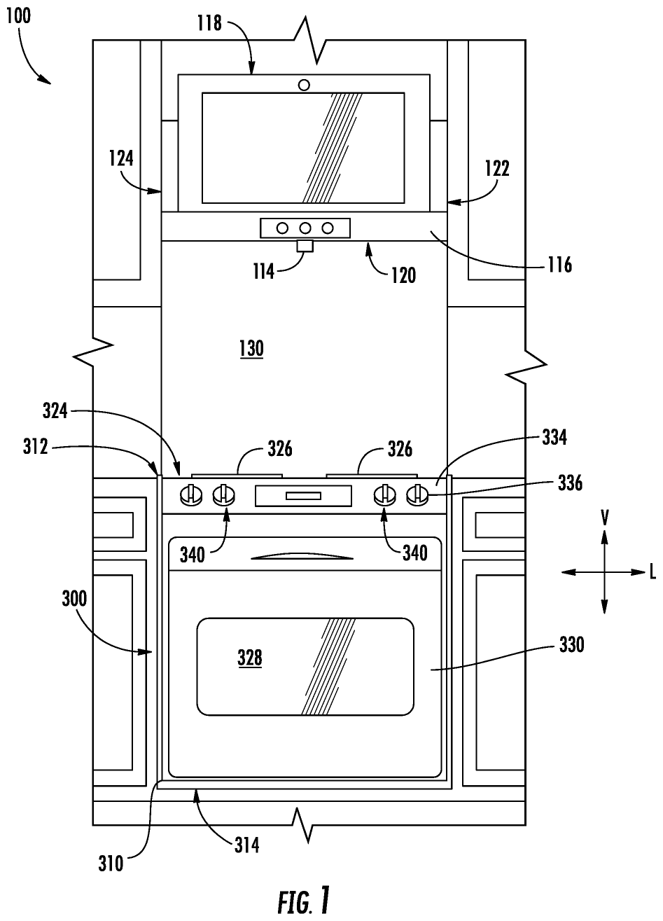

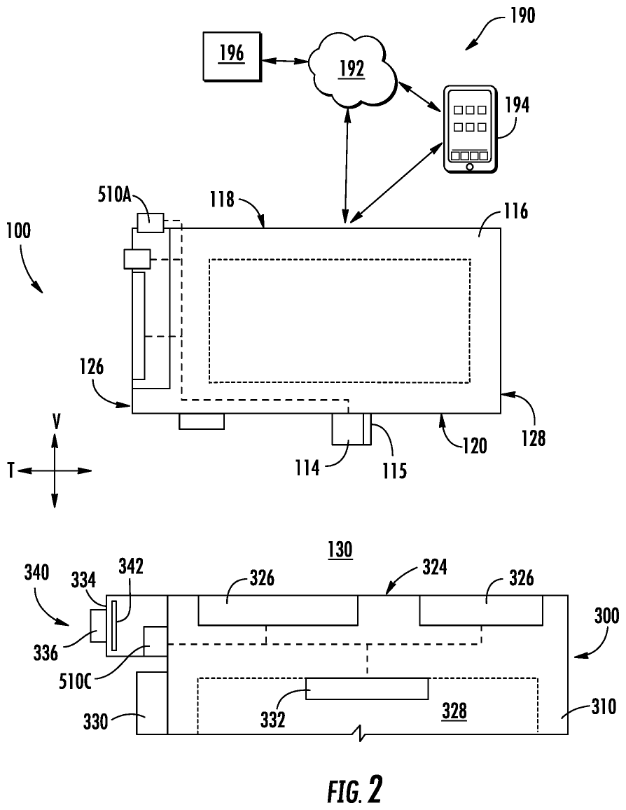

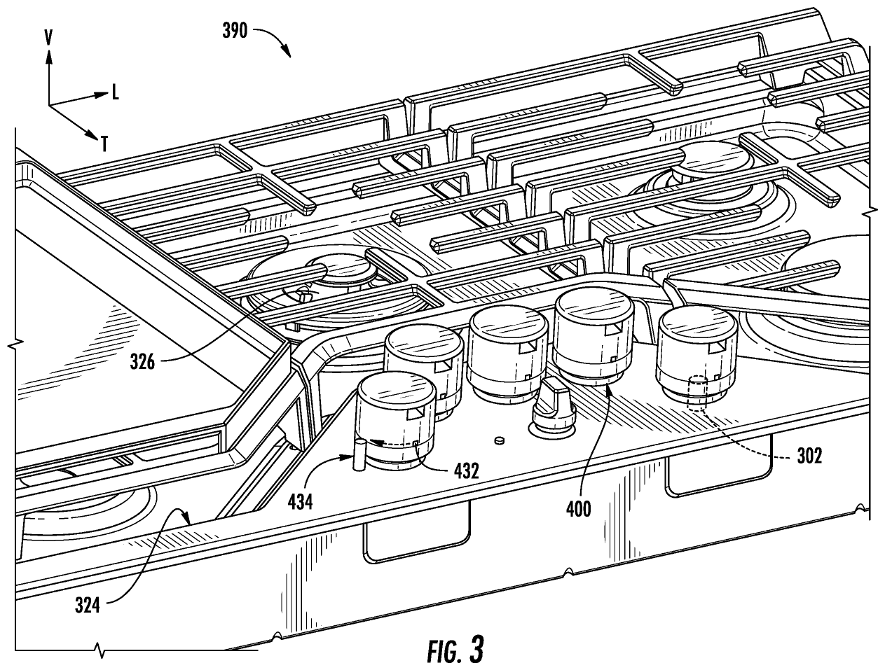

Turning to the figures, FIGS. 1 and 2 provide various views of a system 100 including a cooktop appliance 300 according to exemplary embodiments of the present disclosure. According to some embodiments, system 100 may be referred to as a kitchen hub. In detail, the kitchen hub may incorporate several traditional kitchen appliances (e.g., a cooktop, an oven, a microwave, a display device, a network device, etc.) which may communicate with each other via a network such as a wireless network. It should be understood that the present disclosure may be incorporated within a kitchen hub (such as illustrated and described with reference to FIGS. 1 and 2), a stand-alone cooktop appliance 300 (such as illustrated and described with reference to FIG. 3), or any other free-standing range or cooktop (e.g., incorporating one or more control knobs). Accordingly, the description is not limited to the examples given herein.

As shown, cooktop appliance 300 generally defines a vertical direction V, a lateral direction L, and a transverse direction T. The vertical, lateral, and transverse directions are mutually perpendicular and form an orthogonal direction system. In some embodiments, cooktop appliance 300 extends along the vertical direction V between a top portion 312 and a bottom portion 314; along the lateral direction L between a left side portion and a right side portion; and along the traverse direction T between a front portion and a rear portion.

Cooktop appliance 300 may include a housing or cabinet 310 that defines a top surface 324 and control panel 334. As shown, one or more heating elements 326 are mounted to cabinet 310 at top surface 324 for use in, for example, heating or cooking operations. In one example embodiment, top surface 324 is constructed with ceramic glass. In other embodiments, however, top surface 324 may include another suitable material, such as a metallic material (e.g., steel) or another suitable non-metallic material. Heating elements 326 may be various sizes and may employ any suitable method for heating or cooking an object, such as a cooking utensil and its contents. In certain embodiments, one or more of the heating elements 326 are provided as electric heating elements (e.g., resistive heating element, radiant heating element, induction heating element, etc.). In some embodiments, heating element 326 uses a heat transfer method, such as electric coils or gas burners, to heat the cooking utensil. In other embodiments, however, heating element 326 uses an induction heating method to heat the cooking utensil directly.

In optional embodiments, cooktop appliance 300 includes an insulated cabinet 310 that defines a cooking chamber 328 selectively covered by a door 330. One or more heating elements 332 (e.g., top broiling elements or bottom baking elements) may be enclosed within cabinet 310 to heat cooking chamber 328. Heating elements 332 within cooking chamber 328 may be provided as any suitable element for cooking the contents of cooking chamber 328, such as an electric resistive heating element, a gas burner, microwave element, halogen element, etc. Thus, cooktop appliance 300 may be referred to as an oven range appliance. As will be understood by those skilled in the art, cooktop appliance 300 is provided by way of example only, and the present subject matter may be used in any suitable cooking appliance, such as a double oven range appliance or a standalone cooktop (e.g., fitted integrally with a surface of a kitchen counter). Thus, the example embodiments illustrated in figures are not intended to limit the present subject matter to any particular cooking chamber or heating element configuration, except as otherwise indicated.

As illustrated, control panel 334 may be provided on cooktop appliance 300. Although shown at front portion of cooktop appliance 300, another suitable location or structure (e.g., a backsplash) for supporting control panel 334 may be provided in alternative embodiments. In some embodiments, control panel 334 includes one or more user inputs or controls 336, such as one or more of a variety of electrical, mechanical, or electro-mechanical input devices. In other words, controls 336 may be mounted to cabinet 310 at control panel 334. Controls 336 may include, for example, rotary dials, knobs, push buttons, etc. A controller 510C may be operably coupled (e.g., wirelessly coupled or electrically coupled) to and in communication with control panel 334 and controls 336 through which a user may select various operational features and modes and monitor progress of cooktop appliance 300. In certain embodiments, one or more of the controls 336 is included with a multicolor light display 342 as part of an input assembly 340 that is operably coupled to controller 510C. In additional or alternative embodiments, control panel 334 includes a display component, such as a digital appliance screen that is operably coupled to controller 510C and configured to provide operational feedback to a user. In certain embodiments, control panel 334 represents a general purpose I/O (“GPIO”) device or functional block.

As shown, controller 510C is operably coupled to control panel 334 and its controls 336. Controller 510C may also be operably coupled to various operational components of cooktop appliance 300 as well, such as heating elements (e.g., 326, 332), sensors, etc. Input/output (“I/O”) signals may be routed between controller 510C and the various operational components of cooktop appliance 300. Thus, controller 510C can selectively activate and operate these various components. Various components of cooktop appliance 300 are operably coupled to controller 510C via one or more communication lines such as, for example, conductive signal lines, shared communication busses, or wireless communications bands.

In some embodiments, controller 510C includes one or more memory devices and one or more processors. The processors may be any combination of general or special purpose processors, CPUs, or the like that can execute programming instructions or control code associated with operation of cooktop appliance 300. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 510C may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 510C includes a network interface such that controller 510C can connect to and communicate over one or more networks (e.g., network 192, described below) with one or more network nodes. Controller 510C can also include one or more transmitting, receiving, or transceiving components for transmitting/receiving communications with other devices communicatively coupled with cooktop appliance 300. Additionally or alternatively, one or more transmitting, receiving, or transceiving components can be located off board controller 510C. Generally, controller 510C can be positioned in any suitable location throughout cooktop appliance 300. For example, controller 510C may be located proximal to or behind control panel 334 toward a front portion of cooktop appliance 300.

In some embodiments, cooktop controller 510C is provided as or as part of controller 510A. In alternative embodiments, cooktop controller 510C is a discrete unit in selective operable communication with a controller 510A. Further still, as will be described in further detail below, cooktop controller 510C may simply control one or more of the heating elements 326 in response to inputs (e.g., rotational inputs) from the one or more controls 336 (e.g., control knobs).

One or more casings (e.g., hood casing 116) may be provided above cooktop appliance 300 along the vertical direction V. For example, a hood casing 116 may be positioned above cooktop appliance 300. Hood casing 116 may include a plurality of outer walls and generally extend along the vertical direction V between a top end 118 and a bottom end 120; along the lateral direction L between a first side end 122 and a second side end 124; and along the transverse direction T between a front end 126 and a rear end 128. In some embodiments, hood casing 116 is spaced apart from top surface 324 along the vertical direction V. An open region 130 may thus be defined along the vertical direction V between top surface 324 and bottom end 120.

In optional embodiments, hood casing 116 is formed as a range hood. However, a range hood is provided by way of example only. Other configurations may be used within the spirit and scope of the present disclosure. For example, hood casing 116 could be part of a microwave or other appliance designed to be located over top surface 324. Hood casing 116 may also be provided as a dedicated support frame without any other specific function or capability. Moreover, although a generally rectangular shape is illustrated, any suitable shape or style may be adapted to form the structure of hood casing 116.

In certain embodiments, one or more camera assemblies 114 are provided to capture images (e.g., static images or dynamic video) of a portion of cooktop appliance 300. Generally, each camera assembly 114 may be any type of device suitable for capturing a picture or video. As an example, each camera assembly 114 may be a video camera or a digital camera with an electronic image sensor [e.g., a charge coupled device (CCD) or a CMOS sensor]. Camera assembly 114 may be in operable communication with controller 510A such that controller 510A may receive an image signal from camera assembly 114 corresponding to the picture captured by camera assembly 114. Once received by controller 510A, the image signal may be further processed at controller 510A or transmitted to a separate device (e.g., remote server 404) in live or real-time for remote viewing (e.g., via one or more social media platforms). Optionally, one or more microphones (not pictured) may be associated with one or more of the camera assemblies 114 to capture and transmit audio signal(s) coinciding (or otherwise corresponding) with the captured image signal(s).

In exemplary embodiments, camera assembly 114 is positioned above top surface 324 (e.g., along the vertical direction V). In some such embodiments, camera assembly 114 is mounted (e.g., fixedly or removably) to hood casing 116. When assembled, camera assembly 114 may be positioned directly above top surface 324.

It should be noted that camera assembly 114 may be provided independently from hood casing 116. In detail, as described hereinafter, system 100 may include camera assembly 114, a knob assembly 400 (described below), and an independent camera controller 115. Camera assembly 114 may be positioned adjacent to (e.g., above) any suitable cooktop, such as cooktop appliance 300. Camera assembly 114 may, through a wireless connection module provided therein, communicate with knob assembly 400, as will be described in more detail below.

Referring still to FIG. 2, a schematic diagram of an external communication system 190 will be described according to an exemplary embodiment of the present subject matter. In general, external communication system 190 is configured for permitting interaction, data transfer, and other communications with system 100. For example, this communication may be used to provide and receive operating parameters, cycle settings, performance characteristics, user preferences, user notifications, or any other suitable information for improved performance of system 100.

External communication system 190 permits controller (e.g., controller 510C, 510A) of system 100 to communicate with external devices either directly or through a network 192. For example, a consumer may use a consumer device 194 to communicate directly with system 100. For example, consumer devices 194 may be in direct or indirect communication with system 100, e.g., directly through a local area network (LAN), Wi-Fi, Bluetooth, Zigbee, etc. or indirectly through network 192. In general, consumer device 194 may be any suitable device for providing and/or receiving communications or commands from a user. In this regard, consumer device 194 may include, for example, a personal phone, a tablet, a laptop computer, or another mobile device.

In addition, a remote server 196 may be in communication with system 100 and/or consumer device 194 through network 192. In this regard, for example, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g., TCP/IP, HTTP, SMTP, FTP), encodings or formats (e.g., HTML, XML), and/or protection schemes (e.g., VPN, secure HTTP, SSL).

In general, network 192 can be any type of communication network. For example, network 192 can include one or more of a wireless network, a wired network, a personal area network, a local area network, a wide area network, the internet, a cellular network, etc. According to an exemplary embodiment, consumer device 194 may communicate with a remote server 196 over network 192, such as the internet, to provide user inputs, transfer operating parameters or performance characteristics, receive user notifications or instructions, etc. In addition, consumer device 194 and remote server 196 may communicate with system 100 to communicate similar information.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more appliances, other communication protocols and steps may be implemented, etc. These variations and modifications are contemplated as within the scope of the present subject matter.

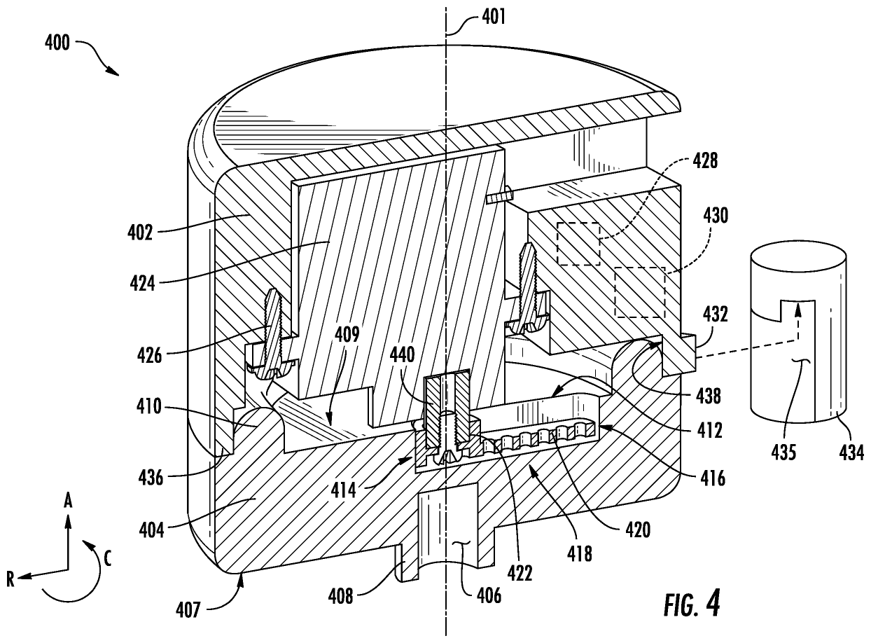

Referring now to FIGS. 3 and 4, a control knob assembly 400 will be described in detail. In describing control knob assembly 400, a coordinate system defined by an axial direction A, a radial direction R, and a circumferential direction C will be predominantly used. It should be understood that in some circumstances, certain referential directions may be parallel with previously defined direction (e.g., vertical, lateral, transverse). Control knob assembly 400 may be removably coupled to a cooktop (e.g., cooktop appliance 300). For instance, control knob assembly 400 may replace one or more traditional or factory control knobs provided on the cooktop. It should be noted that control knob assembly 400 may be coupled to any suitable cooktop appliance, including cooktop appliance 300 shown in FIGS. 1 and 2 as well as stand-alone cooktop appliances, countertop cooktop appliances, combination oven/cooktop appliances, or the like. For example, a stand-alone cooktop 390 is provided in FIG. 3, including a plurality of control knob assemblies 400 attached thereto. Stand-alone cooktop 390 may include features similar to those described above with reference to system 100, including top surface 324, heating elements 326, control panel 334, etc. According, like reference numerals will refer to like features where appropriate.

Control knob assembly 400 may include a knob housing 402 and a knob base 404. Knob housing 402 may be rotatable with respect to knob base 404 (e.g., about the circumferential direction C), and vice versa. For instance, as shown with respect to FIG. 3, knob assembly 400 may be selectively attached to cooktop appliance 300. According to this embodiment, control knob assembly 400 may fit onto a rotatable post (or stove pin) 302 extending (e.g., along the axial direction A) from top surface 324 of cooktop appliance 300. As would be understood, rotatable post 302 may be operably connected with controller 510C such that a rotation of rotatable post 302 (e.g., clockwise or counterclockwise) sends a signal to controller 510C to adjust a heat output from one or more heating elements 326. Accordingly, knob assembly 400 may assist (e.g., automatically) in rotating the rotatable post 302 to adjust the heat output of one or more heating elements 326.

Knob base 404 may include an insertion cavity 406 formed therein. With reference to FIG. 4, insertion cavity 406 may be formed into a bottom surface 407 of knob base 404 along the axial direction A. It should be noted that “bottom surface” as used herein is merely for reference, and that the surface into which insertion cavity 406 is formed may vary according to specific embodiments (e.g., front facing rotatable posts). Insertion cavity 406 may selectively receive rotatable post 302 therein when knob assembly is attached to cooktop appliance 300. Insertion cavity 302 may be a blind hole penetrating to a predetermined depth within knob base 404. Additionally or alternatively, insertion cavity 406 may include one or more locking features configured to fix knob base 404 to rotatable post 302 (e.g., a chamfered edge, axial grooves, etc.). Accordingly, when knob base 404 is rotated, rotatable post 302 may also be rotated.

Knob base 404 may, in some applications, include a boss 408 extending from bottom surface 407 (e.g., along the axial direction A). For instance, boss 408 may at least partially surround and define insertion cavity 406. Advantageously, when knob assembly 400 is attached to rotatable post 302, a clearance gap may be formed between knob base 404 (e.g., bottom surface 407) and top surface 324 of stand-alone cooktop 390. Boss 408 may extend to any suitable length from bottom surface 407 so as to assist in forming insertion cavity 406. Additionally or alternatively, boss 408 may be formed at or near a center of knob base 404 (e.g., along the radial direction R). Thus, an axis of rotation 401 of knob assembly 400 may be defined through the center of knob assembly 400, boss 408, and insertion cavity 406.

Knob base 404 may include a locating ridge 410. In detail, locating ridge 410 may protrude from a top surface 409 of knob base 404 (e.g., opposite bottom surface 407 and along the axial direction A opposite from an extending direction of boss 408). Locating ridge 410 may be formed circumferentially about top surface 409 of knob base 404 (e.g., about a center point formed on axis of rotation 401). Locating ridge 410 may be formed as a semi-circular hump, for instance, as seen along an axial cross-section (FIG. 4). Additionally or alternatively, locating ridge 410 may be provided a predetermined distance inward (e.g., along radial direction R) from the outer edge of top surface 409 of knob base 404. Accordingly, locating ridge 410 may define a rotational path along which knob housing 402 rotates with respect to knob base 404 (or vice versa).

Knob base 404 may include a receiving groove 412 formed therein. In detail, receiving groove 412 may be formed into top surface 409 of knob base 404. A first end 414 of receiving groove 412 may be provided at or near the radial center of knob base 404. A second end 416 of receiving groove 412 may be provided at or near locating ridge 410. For instance, receiving groove 412 may extend along the radial direction R from the center of knob housing 404 to locating ridge 410. Receiving groove 412 may be formed to a predetermined depth (e.g., along the axial direction A). For instance, the depth of receiving groove 412 may be such that receiving groove 412 does not interfere with insertion cavity 406. As shown particularly in FIG. 4, receiving groove 412 does not connect with insertion cavity 406.

A key 418 may be provided within receiving groove 412. Key 418 may extend the length of receiving groove 412 (e.g., along the radial direction R). For instance, key 418 may include a key body 420 and a keyhole 422. Keyhole 422 may operably connect with a motor (described below). As will be explained in further detail, the motor may selectively provide a rotational force to key 418 to rotate knob base 404 with respect to knob housing 402.

Knob housing 402 may be configured to receive a motor 424 therein. In detail, motor 424 may be housed within knob housing 402 and fixed relative to knob housing 402. One or more fasteners 426 may selectively couple motor 424 to knob housing 402 (e.g., within a motor receiving cavity). Motor 424 may be any suitable motor capable of providing rotational input. For instance, motor 424 may be a servo motor, a stepper motor, or the like. Motor 424 may be connected to a battery 428 provided within knob housing 402. Thus, battery 428 may selectively provide power to motor 424 according to an input signal (described below). Additionally or alternatively, knob housing 402 may include a wireless connection module 430. Wireless connection module 430 may communicate with camera assembly 114 (e.g., via camera controller 115). As would be understood, wireless connection module 430 may also be connected with battery 428. As will be described below, camera assembly 114 and control knob assembly 400 may operate in tandem to perform an intelligent cooking operation.

Knob housing 402 may include a stopper 432. In detail, stopper 432 may extend from knob housing 402 along the radial direction R. Stopper 432 may be defined as a ridge, bump, tab, or any other suitable protrusion. Stopper 432 may selectively restrain a rotational movement of knob housing 402 with respect to top surface 324 of, e.g., cooktop appliance 300 (or stand-alone cooktop 390 as shown in FIG. 3). For instance, stopper 432 may selectively engage with a restrainer (or restraint mechanism) 434 extending (e.g., along the axial direction A) from top surface 324. For instance, restrainer 434 may protrude from top surface 324 to a predetermined height so as to interact with stopper 432. Restrainer 434 may be assembled or otherwise connected to top surface 324 via a fastener, an adhesive, a connector, or any suitable means.

For at least one example, stove pin 302 may operate as a common stove pin. In order to initiate a heating operation (e.g., within heating element 326), a user may first push the connected knob (e.g., knob assembly 400) axially inward (e.g., toward top surface 324) and initiate a rotation about the circumferential direction C. Once the rotation of stove pin 302 passes a predetermined point, the user may release pressure in the axial direction A. The stove pin 302 may not rotate freely without axial pressure. Further, for motor 424 to be able to rotate stove pin 302, knob housing must be fixed (e.g., restrained from rotation about the circumferential direction C) with respect to top surface 324. Thus, stopper 432 may become engaged with restrainer 434. According to at least one embodiment, as schematically illustrated in FIGS. 3 and 4, stopper 432 may be rotated into a retention groove 435 formed in restrainer 434. It should be noted that this connection is merely exemplary, and other suitable connections may be utilized. For instance, the connection between stopper 432 and restrainer 434 may be a magnetic connection, a latch connection, a snap connection, or the like. Accordingly, knob housing 402 is fixed from rotating while knob base 404 is rotated by motor 424. As would be understood, the user must then manually rotate knob assembly 400 out from restrainer 434 (e.g., retention groove 435) to fully stop the cooking process.

According to at least one operation, a user rotates control knob assembly 400 (e.g., knob housing 402 and knob base 404) until stopper 432 is engaged with restrainer 434. At this point, knob housing 402 is restrained from rotating (e.g., with respect to top surface 324). Inputs received by motor 424 (e.g., via wireless connection module 430) will subsequently cause motor 424 to provide a rotational input to knob base 404. Since knob base 404 is connected to rotatable post (stove pin) 302, the rotational input to knob base 404 subsequently rotates rotatable post 302, signaling an adjustment to the heat output of heating element 326. Advantageously, control knob assembly 400 (together with camera assembly 114 and camera controller 115) may automatically and intelligently control an operation of heating element 326 and indeed a cooking operation performed thereon.

Knob housing 402 may include a guide lip 436. In detail, a portion of knob housing 402 may form guide lip 436, e.g., proximate knob base 404. As shown particularly in FIG. 4, guide lip 436 may extend along the axial direction A at an outer circumferential portion of knob housing 402. Additionally or alternatively, guide lip 436 may be formed around the circumference of knob housing 402. Moreover, guide lip 436 may define an inner circumferential wall 438. Inner circumferential wall 438 may selectively contact locating ridge 410. Accordingly, as knob base 404 is rotated with respect to knob housing 402, inner circumferential wall 438 of guide lip 436 may slide about the circumferential direction C along locating ridge 410. Advantageously, a smooth and constrained motion of knob base 404 may be ensured by the interaction between guide lip 436 and locating ridge 410.

Motor 424 may include a rotating shaft 440. Rotating shaft 440 may extend from motor 424 along the axial direction A. For instance, rotating shaft 440 may extend along the axial direction A toward knob base 404. As seen in FIG. 4, rotating shaft 440 may be centered along axis of rotation 401. Accordingly, the rotational input from motor 424 is delivered to rotating shaft 440. Rotating shaft 440 may be configured to operably connect with key 418. In detail, rotating shaft 440 may be accepted within keyhole 422 of key 418. In some embodiments, rotating shaft 440 is fixed to keyhole 422. Accordingly, as motor 424 rotates rotating shaft 440, rotating shaft 440 in turn provides rotation to knob base 402. As described above, since knob base 404 is rotatably fixed to rotatable post 302, rotatable post 302 is rotated. Consequently, a signal is delivered to controller 510C to adjust a heat output of heating element 326.

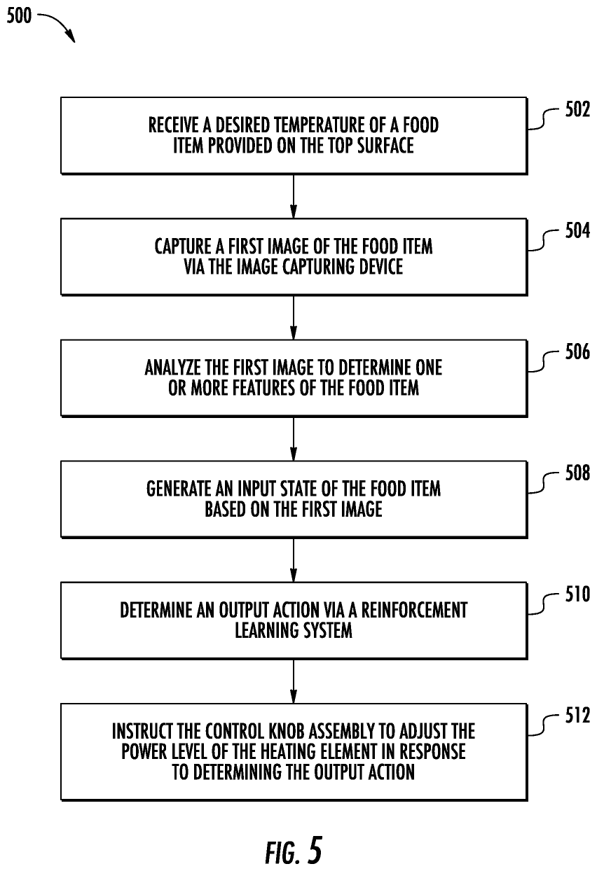

Referring now to FIG. 5, a method 500 of operating a control system will be described in detail. Hereinafter, “control system” may refer to system 100. In detail, the control system may include an image capturing device (e.g., camera assembly 114), a camera controller (e.g., camera controller 115), and a knob assembly (e.g., knob assembly 400). Accordingly, the described control system may be retrofitted to a wide range of commercially available cooking appliances, including stand-alone cooktops, cooktop ranges, single burners, and the like. Although the discussion below refers to the exemplary method 500 of operating control system 100, one skilled in the art will appreciate that the exemplary method 500 is applicable to any suitable domestic appliance capable of performing a cooking operation. In exemplary embodiments, the various method steps as disclosed herein may be performed by camera controller 115 and/or a separate, dedicated controller.

At step 502, method 500 may include receiving a desired temperature of a food item provided on the top surface of a cooking appliance. In detail, a user may wish to initiate a cooking operation. The user may input information regarding the cooking operation, for example, into a control panel (e.g., control panel 334) of the cooking appliance. In some embodiments, the user inputs information to a connected mobile device, for example, through a network (e.g., network 190). The input may be transmitted to the operational controller. As described above, when the system includes the image capturing device, the camera controller, and the knob assembly, the input is transmitted to the camera controller. Accordingly, the camera controller may control the automatic cooking operation upon receiving the input.

Additionally or alternatively, the input provided to the controller may include, along with the desired temperature, a desired cooked level (e.g., medium rare, medium well, etc.), a desired color of food, a desired appearance of food (e.g., crispy, blackened, etc.), or the like. Accordingly, the controller may receive and store more than one desired attribute of the food to be cooked. The controller may establish an initial cooking operation considering each input.

At step 504, method 500 may include capturing a first image of the food item via the image capturing device. The image capturing device may be any suitable image capturing device, such as a visible light spectrum camera, a thermal imaging camera, an infrared camera, or the like. The controller may instruct the image capturing device to capture the first image at a predetermined time. According to some embodiments, the first image is captured at the initiation of the cooking operation (e.g., when the heating element is activated). As described above, the heating element may be initially turned on by the user.

At step 506, method 500 may include analyzing, by one or more computing devices using a machine learning image recognition model, the first image to determine one or more features of the food item. In detail, the controller may perform an image analysis on the captured first image. In addition, it should be appreciated that this image analysis or processing may be performed locally (e.g., by the controller) or remotely (e.g., by a remote server).

According to exemplary embodiments of the present subject matter, step 506 of analyzing the first image may include analyzing the image of the food item using a neural network classification module and/or a machine learning image recognition process. In this regard, for example, the controller may be programmed to implement the machine learning image recognition process that includes a neural network trained with a plurality of images of food items including various different food items, images of different levels of cooking performed on the same food items, etc. By analyzing the image(s) captured using this machine learning image recognition process, the controller may properly evaluate the one or more characteristics of the food item (or cooking utensil), e.g., by identifying the trained image that is closest to the obtained image.

As used herein, the terms image recognition process and similar terms may be used generally to refer to any suitable method of observation, analysis, image decomposition, feature extraction, image classification, etc. of one or more images or videos taken within a refrigerator appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by the camera and the controller may be programmed to perform such processes and take corrective action.

According to an exemplary embodiment, controller may implement a form of image recognition called region based convolutional neural network (“R-CNN”) image recognition. Generally speaking, R-CNN may include taking an input image and extracting region proposals that include a potential object, such as a particular region containing a food item, a portion of the food item, or the like. In this regard, a “region proposal” may be regions in an image that could belong to a particular object, such as a particular portion of the food item, utensil, or the like. A convolutional neural network may then be used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “Mask R-CNN” and the like.

According to still other embodiments, the image recognition process may use any other suitable neural network process. For example, step 506 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to analyze the image to determine various attributes or characteristics of the food item. In addition, a K-means algorithm may be used. Other image recognition processes are possible and within the scope of the present subject matter.

It should be appreciated that any other suitable image recognition process may be used while remaining within the scope of the present subject matter. For example, step 506 may include using a deep belief network (“DBN”) image recognition process. A DBN image recognition process may generally include stacking many individual unsupervised networks that use each network's hidden layer as the input for the next layer. According to still other embodiments, step 506 may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence (“AI”) analysis techniques, and combinations of the above described or other known methods may be used while remaining within the scope of the present subject matter.

According to still other embodiments, a reinforcement learning system may be used in analyzing the first image. For instance, the reinforcement learning system may incorporate a policy map model. In detail, the policy map model may associate a given input state of the food item with a determined output action based on an interpreted reward. According to at least one example, the input state of the food item includes a determined temperature, a determined color, and/or any other determined attribute associated with the food item. The policy map model may have a predetermined reward associated with the input state. In other words, each of the input state and the predetermined reward are analyzed collectively by the reinforcement learning system. In response, the system may perform an action based on the input that will most closely result in the reward. For instance, if the input state is a particular temperature and the reward is the desired temperature, the action may be determined by the system to achieve the reward (e.g., the desired temperature).

Accordingly, at step 508, method 500 may include generating an input state of the food item based on the first image analysis. In detail, the system may determine that an exterior temperature of the food item is a first predetermined temperature. The first predetermined temperature of the food item may be within a predetermined range or threshold of the desired temperature (e.g., as input by the user). Thus, the input state of the food may be stored as the exterior temperature of the food item. In some embodiments, the controller extrapolates or otherwise estimates an internal temperature of the food item (e.g., based on one or more additional attributes of the food item, such as a thickness, surface area, etc.).

The reinforcement learning system may be, for example, an imitation learning model, a target control model, or the like. In detail, the imitation learning model may follow a learned sequence of targets (e.g., temperature targets for the food item). The sequence of temperature targets may be determined via repetitive iterations of cooking operations. Moreover, the sequence of temperature targets may be specific to produce desired outcomes. For instance, the sequence of temperature targets may include times to add or remove heat from the heating element in order to produce the desired outcome for the food item.

The target control model may incorporate the above-described reward setting. For instance, the target control model may continually monitor the temperature of the food item (e.g., the current temperature) and compare the current temperature to the target (or desired) temperature. Accordingly, the learned model may continually monitor and adjust the cooking operation to achieve the desired result.

At step 510, method 500 may include determining an output action via a reinforcement learning system. As described above, the reinforcement learning system may include a neural network policy. Moreover, the output action may include adjusting the control knob assembly (e.g., control knob assembly 400). According to at least one example, the controller may determine that an amount of heat produced by the heating element needs to be reduced in order to achieve the desired temperature of the food item (e.g., the reward). Accordingly, the controller may send a signal wireless signal (e.g., through wireless connection module 430) to a motor (e.g., motor 424) within the control knob assembly to adjust the temperature of the heating element. The motor may then provide a rotation input to an input post (e.g., rotatable post 302) to reduce the heat output of the heating element.

According to some embodiments, the image capturing device may capture multiple successive images in order to monitor and timely adjust certain parameters of the cooking operation (e.g., the heat output of the heating element). Thus, it should be understood that the method described herein is not limited to the steps set forth above.

At step 512, method 500 may include instructing the control knob assembly to adjust the power level of the heating element in response to determining the output action. As described above, the controller may determine the appropriate output action in response to the image analysis. Accordingly, the controller may, via wireless connection, instruct the control knob assembly to rotate a predetermined amount. In turn, the rotating post (e.g., stove pin) may rotate together with a portion of the control knob assembly. The heat output of the heating element may be adjusted as a result. For example, the heat output may be reduced when the output action calls for lower heat.

According to the description above, an automatic control system for a cooking appliance is provided. The automatic control system may include one or more image capturing devices, a controller in operative connection with the one or more image capturing devices, and a control knob assembly. The image capturing device(s) may be one or more of a visible light spectrum camera, a thermal imaging camera, an infrared camera, or the like. The control knob assembly may be in wireless communication with the image capturing device(s). The image capturing device(s) may capture one or more images of a food item on a cooktop of the cooking appliance. The controller may then analyze the captured image(s) to determine an appropriate output. The output may include adjusting a heat output level of a heating element on the cooktop. The control knob assembly may be operably coupled with an input of the cooktop, such as a stove pin. Accordingly, the control knob assembly may selectively rotate the stove pin according to the image analysis done by the controller. The image analysis may include one or more reinforcement learning systems incorporating a policy map model. Thus, an automatic cooking operation may be performed via the control system, resulting in more precisely cooked food items with little to no user interaction during the cooking operation. Additionally or alternatively, as described above, system 100 may include camera assembly 114, camera controller 115, and knob assembly 400, which may collectively be installed to existing cooking appliances as an aftermarket accessory to allow for automated cooking operations to be performed on cooking appliances lacking built-in smart software.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Thus, while the present subject matter has been described in detail with respect to various specific example implementations, each example is provided by way of explanation, not limitation of the disclosure. One of ordinary skill in the art can readily make alterations to, variations of, and equivalents to such implementations. Accordingly, the subject disclosure does not preclude inclusion of such modifications, variations and/or additions to the present subject matter as would be readily apparent to one of ordinary skill in the art. For instance, features illustrated or described as part of one implementation can be used with another implementation to yield a still further implementation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An automatic control system for a cooking appliance, the cooking appliance comprising a top surface, a control panel, a heating element mounted to the top surface, and a user input provided at the control panel, the automatic control system comprising:
at least one control knob assembly for adjusting a power level of the heating element;
an image capturing device configured to capture images of the top surface; and
a controller operably coupled to the at least one control knob assembly and the image capturing device, the controller being configured to perform a series of operations, the series of operations comprising:
receiving a desired temperature of a food item provided on the top surface;
capturing a first image of the food item via the image capturing device;
analyzing, by one or more computing devices using a machine learning image recognition model, the first image to determine one or more features of the food item;
generating an input state of the food item based on the one or more features of the food item;
determining an output action via a reinforcement learning system, the reinforcement learning system comprising a neural network policy; and
instructing the control knob assembly to adjust the power level of the heating element in response to determining the output action.

2. The automatic control system of claim 1, wherein the input state of the food item is an exterior temperature of the food item.

3. The automatic control system of claim 2, wherein the image capturing device is a thermal imaging camera.

4. The automatic control system of claim 3, wherein the series of operations further comprises:
determining the exterior temperature of the food item based on a captured thermal image from the thermal imaging camera.

5. The automatic control system of claim 2, wherein the image capturing device is a visible light spectrum camera.

6. The automatic control system of claim 5, wherein the series of operations further comprises:
determining the exterior temperature of the food item based on a captured visible light image from the visible light spectrum camera.

7. The automatic control system of claim 1, wherein the machine learning image recognition model comprises at least one of a convolution neural network (“CNN”), a region-based convolution neural network (“R-CNN”), a deep belief network (“DBN”), or a deep neural network (“DNN”) image recognition process.

8. The automatic control system of claim 7, wherein the input state of the food item comprises a temperature of the food item, and wherein the output action comprises causing the at least one control knob assembly on the user input to rotate a predetermined amount.

9. The automatic control system of claim 8, wherein the machine learning image recognition model comprises a policy map model, and wherein the controller determines the output action based on a reward setting associated with the input state.

10. The automatic control system of claim 9, wherein the policy map model incorporates an imitation learning model.

11. The automatic control system of claim 9, wherein the policy map model incorporates a target control model.

12. The automatic control system of claim 1, wherein the at least one control knob assembly comprises:
a knob base comprising an insertion cavity;
a knob housing rotatably connected with the knob base; and
a motor provided within the knob housing, the motor configured to selectively rotate the knob base with respect to the knob housing.

13. The automatic control system of claim 12, wherein the one or more features of the food item comprises a measured temperature of the food item, and wherein the series of operations further comprises:
determining that the measured temperature of the food item is within a predetermined range of the desired temperature of the food item; and
adjusting the control knob assembly such that an amount of heat produced by the heating element is reduced.

14. A method of operating a cooking appliance, the cooking appliance comprising a top surface, a heating element, a control knob assembly, and an image capturing device, the method comprising:
receiving a desired temperature of a food item provided on the top surface;
capturing a first image of the food item via the image capturing device;
analyzing, by one or more computing devices using a machine learning image recognition model, the first image to determine one or more features of the food item;
generating an input state of the food item based on the first image analysis;
determining an output action via a reinforcement learning system, the reinforcement learning system comprising a neural network policy; and
instructing the control knob assembly to adjust a power level of the heating element in response to determining the output action.

15. The method of claim 14, wherein the input state of the food item is an exterior temperature of the food item.

16. The method of claim 15, wherein the image capturing device is a thermal imaging camera, the method further comprising:
determining the exterior temperature of the food item based on a captured thermal image from the thermal imaging camera.

17. The method of claim 14, wherein the machine learning image recognition model comprises at least one of a convolution neural network (“CNN”), a region-based convolution neural network (“R-CNN”), a deep belief network (“DBN”), or a deep neural network (“DNN”) image recognition process.

18. The method of claim 17, wherein the image recognition model comprises a policy map model, the method further comprising:
determining the output action based on a reward setting associated with the input state.

19. The method of claim 18, wherein the control knob assembly comprises:
a knob base comprising an insertion cavity;
a knob housing rotatably connected with the knob base; and
a motor provided within the knob housing, the motor configured to selectively rotate the knob base with respect to the knob housing.

20. The method of claim 19, wherein the one or more features of the food item comprises a measured temperature of the food item, the method further comprising:
determining that the measured temperature of the food item is within a predetermined range of the desired temperature of the food item; and
adjusting the control knob assembly such that an amount of heat produced by the heating element is reduced.
